(19) United States
(12) Patent Application Publication
(10) Pub. No.: US 2024/0249614 A1
(43) Pub. Date: Jul. 25, 2024

(54) VEHICLE SENSING AND CLASSIFICATION BASED ON VEHICLE-INFRASTRUCTURE INTERACTION OVER EXISTING TELECOM CABLES

(71) Applicant: NEC Laboratories America, Inc., Princeton, NJ (US)

(72) Inventors: Shaobo HAN, Princeton, NJ (US); Yuheng CHEN, South Brunswick, NJ (US); Ming-Fang HUANG, Princeton, NJ (US); Tingfeng LI, Plainsboro, NJ (US); Ting WANG, WEST WINDSOR, NJ (US)

(73) Assignee: NEC Laboratories America, Inc., Princeton, NJ (US)

(21) Appl. No.: 18/417,769

(22) Filed: Jan. 19, 2024

Related U.S. Application Data
(60) Provisional application No. 63/480,539, filed on Jan. 19, 2023.

(51) Int. Cl. G08G 1/01

(52) U.S. Cl. CPC G08G 1/0116; G08G 1/0112

(57) ABSTRACT

Disclosed are vehicle-infrastructure interaction systems and methods employing a distributed fiber optic sensing (DFOS) system operating with pre-deployed fiber-optic telecommunication cables buried alongside/proximate to highways/roadways which provide 24/7 continuous information stream of vehicle traffic at multiple sites; only require a single optical sensor cable that senses/monitors multiple locations of interest and multiple lanes of traffic; the single optical sensor cable measures multiple related information (multi-parameters) about a vehicle, including driving speed, wheelbase, number of axles, tire pressure, and others, that can be used to derive secondary information such as weight-in-motion; and overall information about a fleet of vehicles, such as traffic congestion or traffic-cargo volume. Different from merely traffic counts, our approach can provide the count grouped by vehicle-types and cargo weights. Precise measurements are facilitated by high temporal sampling rates of the distributed acoustic sensing and a dedicated peak finding algorithm for extracting the timing information reliably.

### CROSS-REFERENCE TO RELATED APPLICATIONS

This application claims the benefit of U.S. Provisional Patent Application Ser. No. 63/480,539 filed Jan. 19, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to DFOS systems, method, and structures that detect and measure vehicle-to-infrastructure interaction over existing telecom cables.

### BACKGROUND OF THE INVENTION

The movement of people and goods is facilitated by vehicles moving along highways and roads. Information about (1) individual vehicles such as vehicle type (wheelbase, number of axles), driving speed, tire condition, weight-in-motion, and (2) a collection of vehicles during a time period such as traffic congestions, and traffic volume manifests the flow of goods and services and provide an object metric about the economic activity, at a local geographic region of interest.

Automatic collection of such information in real-time can be useful for roadway planners and operators. Such information is oftentimes measured separately by special sensors, such as cameras, pneumatic road tubes, piezoelectric sensors, magnetic sensors, fiber Bragg grating (FBG) fiber sensors, etc. However, these sensory solutions exhibit a number of limitations, including point sensors deployed sparsely along the highway or road; they are constrained to regions with data transmission and power supply only, lacking in capability of discriminating vehicles closely following each other under dense traffic or high volume, multiple lane scenarios in highway, affected by light condition, weather such as rain or fog, privacy preserving additional deployment cost and destructive of the road, or using dedicated fiber cables, previous distance fiber sensing and waterfall-based approaches can only provide coarse-grained information such as traffic count and average speed over a period of time, without knowing the precise parameters such as vehicle type or instantaneous speed, and requirements for sophisticated computer vision or machine learning algorithms requiring expensive hardware and high latency.

### SUMMARY OF THE INVENTION

An advance in the art is made according to aspects of the present disclosure directed to a vehicle-infrastructure interaction systems and methods employing a distributed fiber optic sensing (DFOS) system operating with pre-deployed fiber-optic telecommunication cables that are buried alongside/proximate to highways/roadways.

In sharp contrast to the prior art, our inventive systems, and methods according to aspects of the present disclosure: a) provide a 24/7 continuous information stream of vehicle traffic at multiple sites along a roadway; only requires a single optical sensor cable that senses/monitors multiple locations of interest and multiple lanes of traffic; the single optical sensor cable measures multiple related information (multi-parameters) about a vehicle, including driving speed, wheelbase, number of axles, tire pressure, and others, that can advantageously be used to derive secondary information such as weight-in-motion; and overall information about a fleet of vehicles, such as traffic congestion or traffic-cargo volume. Different from merely traffic counts, our approach can provide the count grouped by vehicle-types and cargo weights. Finally, systems, and methods according to aspects of the present disclosure provide precise measurements facilitated by high temporal sampling rates of the distributed acoustic sensing and a dedicated peak finding algorithm for extracting the timing information reliably.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic block diagram showing illustrative sensing setup in which vehicles with multiple axis pass a pair of target locations along a roadway and multiple parameters about the vehicles are sensed via DFOS according to aspects of the present disclosure.

FIG. 3 is a schematic block diagram showing illustrative vehicle measurements based on DAS waveform signals in which a vehicle with two axles passes a pair of target locations along the roadway. The location and number of self-repeated patterns, gap(s) between the patterns, magnitudes and frequencies of the acoustic signals convey information about vehicle type, tire condition, and weight-in-motion according to aspects of the present disclosure.

FIG. 4 is a schematic diagram showing illustrative design/layout for special scenarios such as high-density and/or multiple lane traffic according to aspects of the present disclosure.

FIG. 5 is a schematic diagram showing illustrative operational pipeline for peak-finding based vehicle information estimation according to aspects of the present disclosure.

FIG. 6(A) and FIG. 6(B) are plots showing: FIG. 6(A) comparison of before and after bandpass filter on raw waveform data and; FIG. 6(B) estimation of the number of axles by calculating cumulative magnitude of peaks and counting the number of continuous increasing sections; according to aspects of the present disclosure.

FIG. 7 is a schematic block/flow diagram showing the prediction of multi-parameter of vehicles using supervised model trained with multivariate labels according to aspects of the present disclosure.

FIG. 8 shows results using peak-based method for wheelbase and speed estimation according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

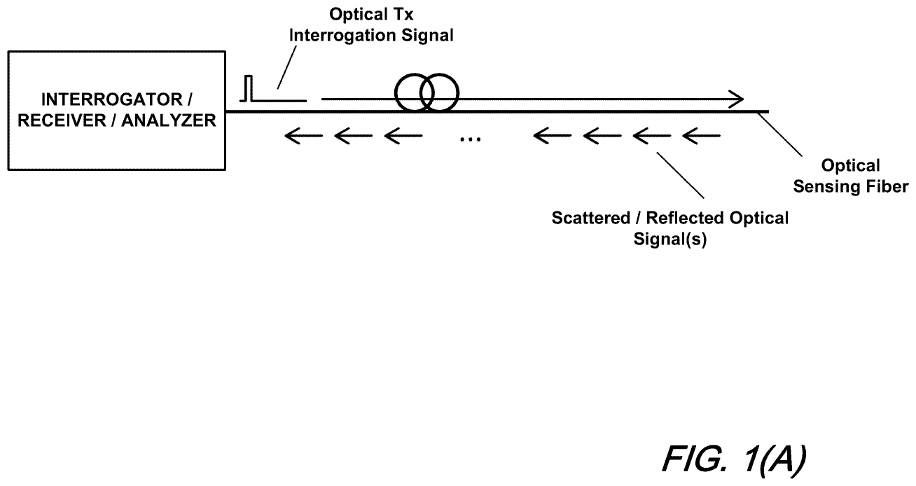

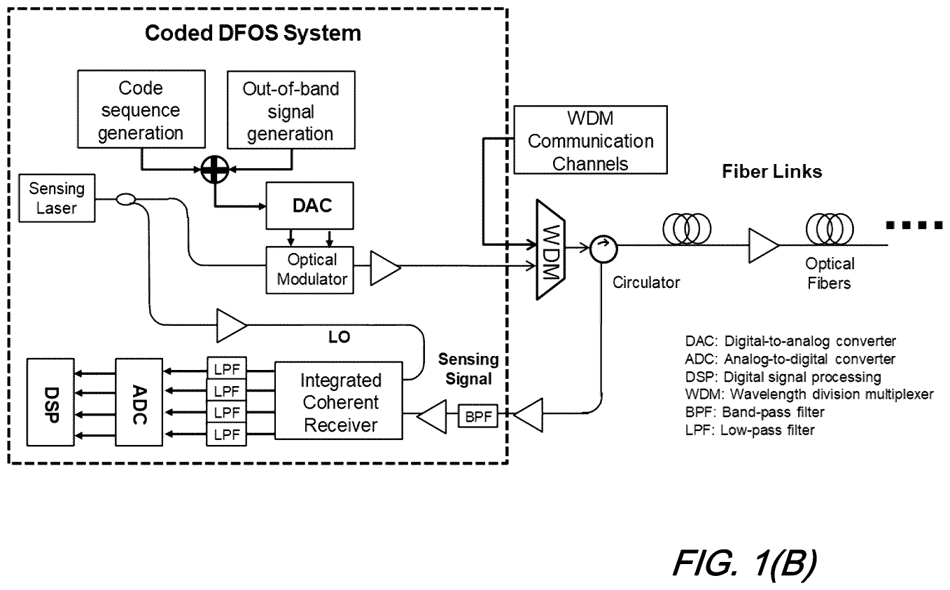

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

As we shall now further show and describe systems, methods, and structures according to aspects of the present invention combines the linear structure of distributed fiber-optic sensing (DFOS), therefore, it inherits the benefits of traditional distributed fiber optic sensing. Meanwhile, it utilizes the vibration/acoustic pattern of vehicles generated at locations proximate to locations along the length of the sensor optical fiber that is part of the DFOS. As a result, it also enjoys the benefits of precise measurements of traditional point sensors and is amendable to sensor fusion, i.e., use in combination with non-acoustic sensors and wireless communications techniques such as camera to enable other sophisticated applications (such as vehicle plate recognition and real-time driver notification).

As those skilled in the art will now understand and appreciate, potential application of our inventive systems, methods, and structures include: Vehicle fault diagnostics and early warning; Gasoline cost and road damage estimation; Precise toll determination and estimation; Economy data generation; Over speed detection and billing systems.

Our inventive systems, methods, and structures detect/collect/analyze vehicle-infrastructure (V2I) interaction. Advantageously, our inventive systems, methods, and structures enhance the safety and productivity of highways and roads, while providing a DOFS based system for smart transportation and smart roads.

Of further advantage, our inventive systems, methods and structures use existing cable architecture, therefore do not incur additional costs of deploy dedicated sensors; utilize acoustic signals generated by vehicles passing auxiliary target locations on/along a roadway, including but not limited to speed bumps, bridge decks, manholes, potholes, or sonic alert pattern (SNAP); detection is based on peak-finding or self-similarity between patterns/signatures generated by a same vehicle, therefore our systems, methods and structures according to the present disclosure are more robust to heterogeneous factors caused by different geographical locations and soil types, and different types of auxiliary targets locations; and dedicated digital signal processing (DAS) and machine learning (ML) algorithms for data processing, which are low-cost, lightweight, and perform in real-time.

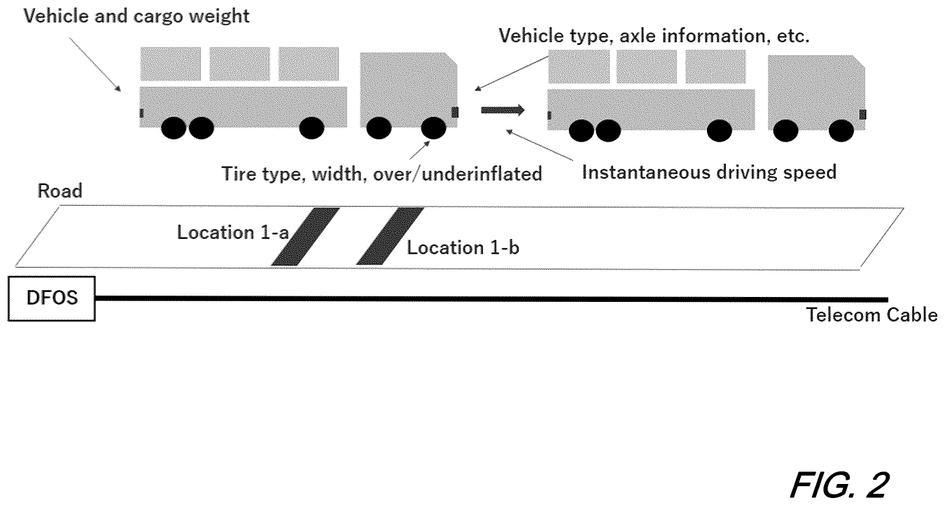

FIG. 2 is a schematic block diagram showing illustrative sensing setup in which vehicles with multiple axis pass a pair of target locations along a roadway and multiple parameters about the vehicles are sensed via DFOS according to aspects of the present disclosure.

As shown in that figure, a sensing layer overlaid on existing deployed fiber networks. The distributed fiber optic sensing system (DFOS) is a distributed acoustic sensing (DAS) integrator located in the control office/central office to collect data from the entire optical fiber sensor cable route. The DFOS system is connected to the field optical sensor fiber to provide sensing functions at multiple sites in a manner of location division multiplex (LDM) in real-time. The fiber can be a dark fiber or operational fiber from service providers.

The precision measurement of multi-parameters of vehicles relies on a pair of targeted locations. Such locations are readily available in the road, such as speed bumps, bridge decks, or sonic nap alert pattern (SNAP). It can also be easily deployed to particular locations or time period of interest. For example, during some special musical or sport events, to some facility (parking lot, gates, stadium, etc.).

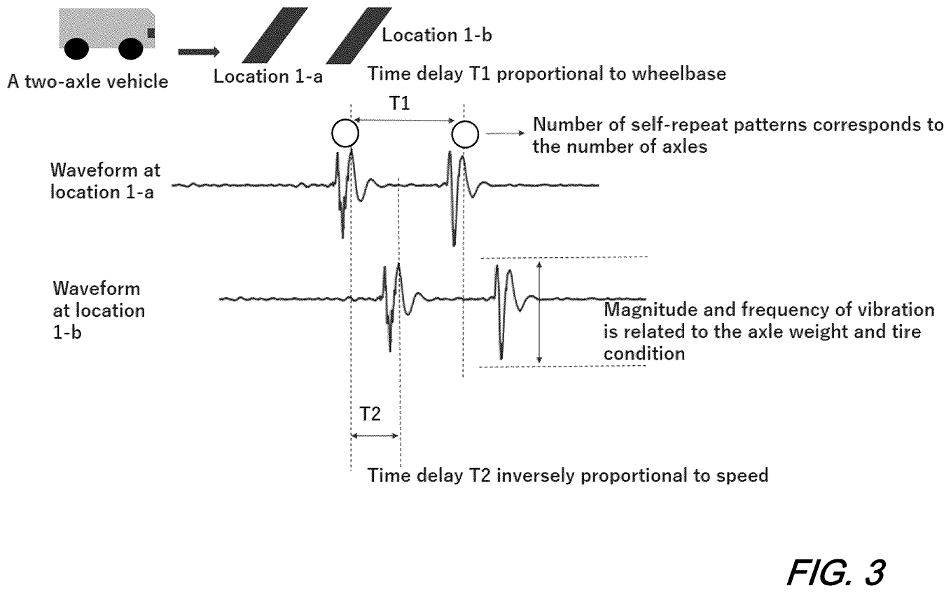

As is known, DFOS measures the displacement on the fiber cable and provides the change of phase waveform as output. A vehicle passing targeted locations will generate acoustic patterns with self-similarity that can be detected. The mechanism is illustrated in FIG. 3, using a two-axle vehicle as an example.

FIG. 3 is a schematic block diagram showing illustrative vehicle measurements based on DAS waveform signals in which a vehicle with two axles passes a pair of target locations along the roadway. The location and number of self-repeated patterns, gap(s) between the patterns, magnitudes and frequencies of the acoustic signals convey information about vehicle type, tire condition, and weight-in-motion according to aspects of the present disclosure.

The algorithmic operations to measure basic information of the vehicle include peak-finding, lagged-correlation computation, moving-window, spatial clustering, and filtering, local averaging, and power spectral density calculation. Vehicle classification can be precisely determined based on the wheelbase and number of axles, such as sedan, truck, etc., regardless of cargo weight. The vehicle counts and driving speed represents the traffic volume and traffic congestion in either short-term or seasonal. Individual vehicles with unusual wheelbases, or excess speed limit can also be detected.

Note that secondary information such as tire pressure information and weight-in-motion requires jointly considering multiple related factors (joint reasoning of instantaneous speed, axle's weight, and vibration patterns). This is not possible with previous point-sensor based solutions, which can only provide (or focus on) a subset of factors.

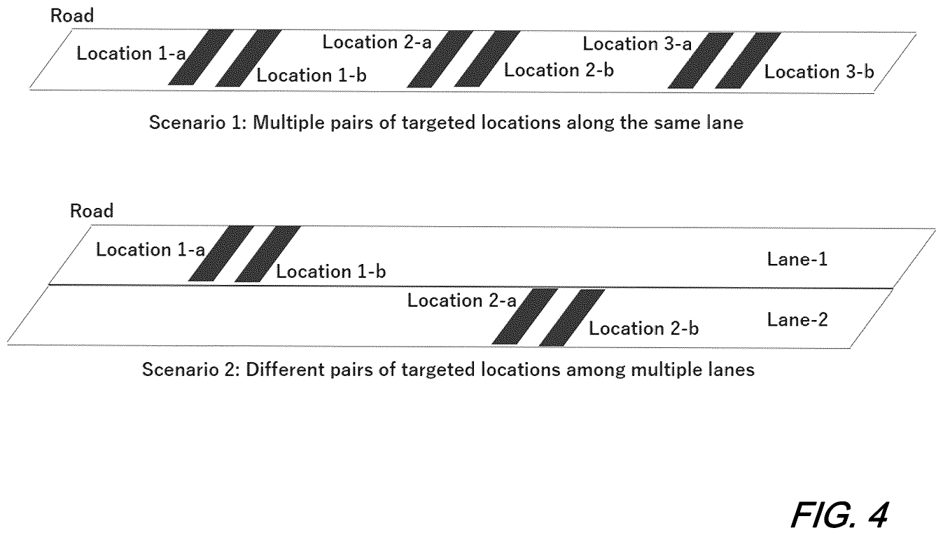

Our inventive systems, methods, and structures according to aspects of the present disclosure advantageously handle high-density and multiple lane scenarios and provide more accurate estimations, by utilizing multiple sets of targeted locations. These special scenarios are illustrated in FIG. 4, which is a schematic diagram showing illustrative design/layout for special scenarios such as high-density and/or multiple lane traffic according to aspects of the present disclosure.

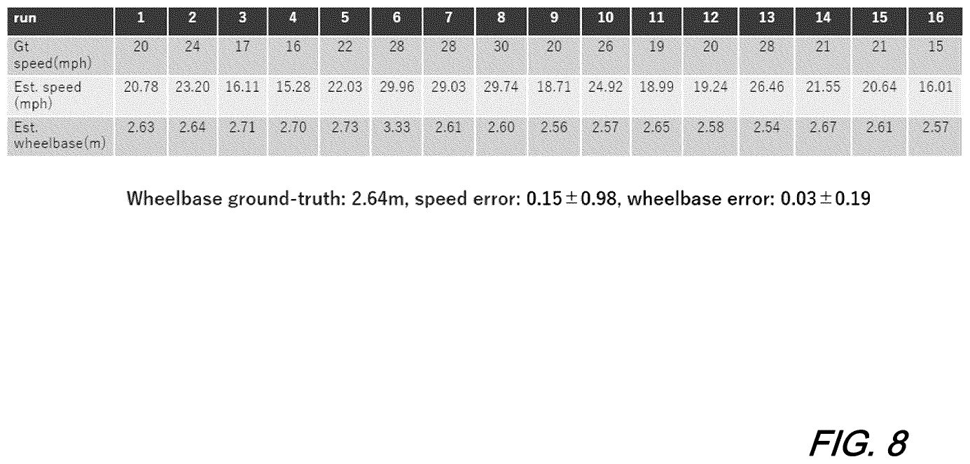

To be more specific, (1) If there are multiple pairs of targeted locations within the same lane, the estimation results can be made more accurate by averaging across multiple pairs (illustrated in B2—FIG. 8 which shows results using peak-based method for wheelbase and speed estimation according to aspects of the present disclosure) or provide a distribution of parameter estimations; (2) The driving direction of vehicles can be inferred by the order of peaks appearing at these targeted locations, and (3) Vehicles passing multiple lanes can naturally be discriminated by pairs of targeted locations in different lanes. Note that the targets must be embedded in the road, rather than on the road side (e.g., utility poles are not viable)

With the fiber sensing setup mentioned previously, we can obtain waveform signals from multiple fiber sensors for vehicle measurements. We now describe in detail the algorithm employed.

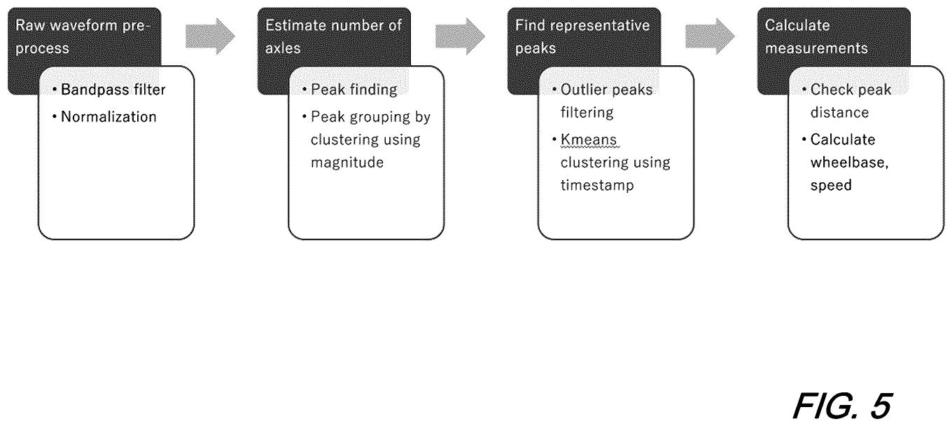

As will be appreciated, one key challenge is to extract precise timing information of events from the raw waveform data. One method for the estimation is based on calculating the distances between peaks of events, in either the original waveform space, or a transformed space. The pipeline is presented in FIG. 5, which is a schematic diagram showing illustrative operational pipeline for peak-finding based vehicle information estimation according to aspects of the present disclosure.

Each raw waveform data is first pre-processed with a bandpass filter with pass frequency between 50 Hz and 200 Hz.

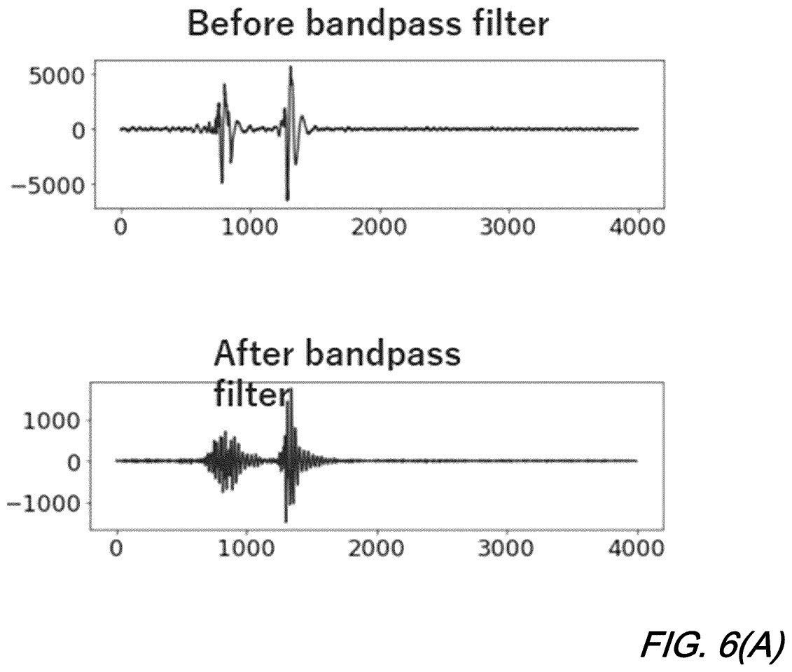

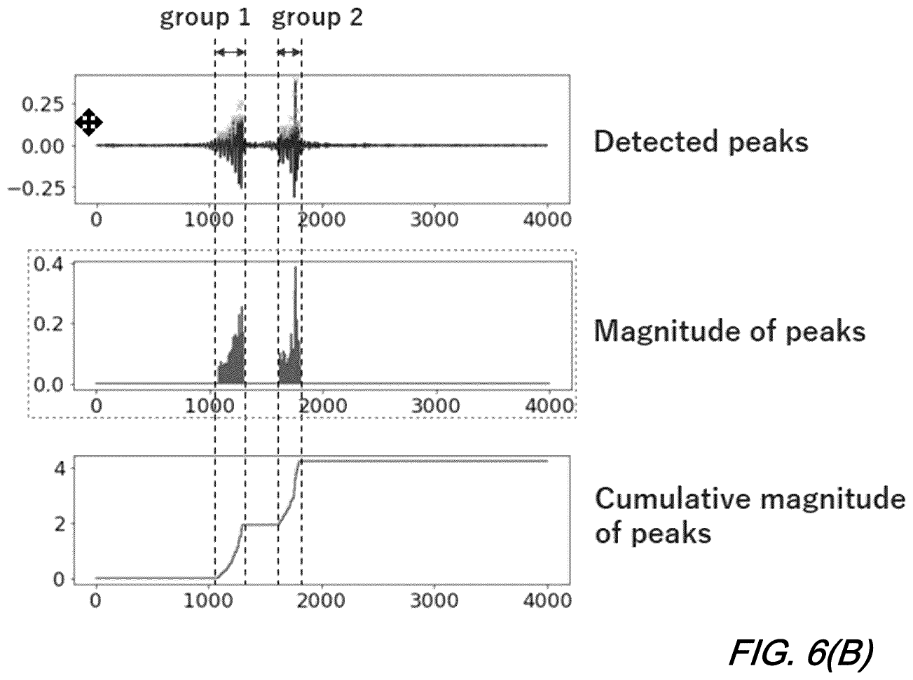

FIG. 6(A) and FIG. 6(B) are plots showing: FIG. 6(A) comparison of before and after bandpass filter on raw waveform data and; FIG. 6(B) estimation of the number of axles by calculating cumulative magnitude of peaks and counting the number of continuous increasing sections; according to aspects of the present disclosure.

As shown in FIG. 6(A), although the amplitude gets weaker, the waveform looks less noisy and peaks become denser, which is beneficial for peak finding as it is less likely that peaks being missed by the detector. The filtered signal is then normalized with mean and standard deviation of all collected data to make sure that different signals take on similar ranges of values so that the thresholds are universally applicable.

### Estimate the Number of Axles.

We estimate the number of axles by calculating cumulative magnitude of peaks and counting the number of continuous increasing sections as shown in FIG. 6(B). For each waveform signal, first detect peaks simple comparison of neighboring values that are above a absolute magnitude threshold. The orange cross symbols mark all detected peaks and their absolute magnitude. Then we calculate cumulative magnitude of all points from original magnitude values. For all non-peak points, their magnitude is zero. We use cumulative magnitude as a feature to do DBSCAN clustering. With a very small neighborhood radius threshold and a very large minimum number of points, this clustering algorithm can accurately find out continuous zero and continuous increasing sections. The total number of continuously increasing sections is the number of axles from this waveform. “group 1” and “group 2” in FIG. 6(B) show the detected continuous increasing sections in this waveform signal. The cumulative magnitude feature could be down sampled before clustering for faster computation. The final estimated number of axles is voted by multiple sensors.

### Find Representative Peaks.

After obtaining the number of axles, i.e., the number of groups of peaks in waveform data, the next step would be determining the timestamp for each group (x coordinate). One intuitive way is to average the x coordinates of all peaks belonging to the group, but this requires all peaks to be within expected range, which is difficult when the waveform is noisy. Thus, we consider the peak with the highest magnitude as the representative peak for this group. Although this peak is not always located at the center, it should be within the “hill” range with a high possibility. To achieve this, we first filter outlier peaks by calculating z score of the x coordinate of each peak and discarding those above a threshold, i.e., subtracting the mean and then dividing by standard deviation. Then we adopt K-means with the estimated number of axles as parameter to cluster the peaks using x coordinates. For each cluster, we are then able to find the representative peak, which is the highest one.

### Calculate Vehicle Measurements.

Before computing the vehicle measurements with representative peaks, we first check if the distance of adjacent peaks is within a reasonable range. If not, then this waveform data is discarded.

Wheelbase. After this, we are able to calculate wheelbase by computing the ratio of wheelbase and the distance of target locations. Specifically, as shown in FIG. 2, assuming the distance between adjacent locations is d meter, the wheelbase ŵ can be estimated with the following equation:

$$\hat{w} = \frac{{T}_{1}}{{T}_{2}} \cdot d , \qquad ( 1 )$$

where T₁ is the time difference between the left and right peak, corresponding to front and rear wheel passing by location 1-a or location 1-b. And T₂ is the time difference between the two left peaks or two right peaks, corresponding to front or rear wheel passing two locations. As there are two estimations of T₁ and T₂, the ratio could be estimated with four combinations. We take the average of the four ratios and multiply with d to get the wheelbase in meter.

Speed. We can estimate the instantaneous driving speed with the following equation:

$$\hat{v} = \frac{d}{{\overline{T}}_{2}} . \qquad ( 2 )$$

Note that T̅₂ is the average time difference calculated by left peaks and right peaks of all waveform signal.

To demonstrate the effectiveness of this method, we conducted 16 test runs with a 2-axle car. The results are shown in Table 1, where “Gt speed” is the speed read from the speedometer on the vehicle by the driver, “Est. speed” and “Est. wheelbase” are estimated speed and wheelbase using the above method. The ground-truth wheelbase of the car is 2.64 m. The estimation error of speed and wheelbase is 0.15±0.98 mph and 0.03±0.19 meters respectively, indicating the estimations are accurate and stable. Meanwhile, multiple sets of targeted locations will lead to more accurate results.

The peak-based method enables accurate wheelbase and speed estimation, and the locations of peaks are also useful for real-time vehicle detection as the first step. However, it is not robust when peaks are not dense, and magnitude varies due to factors like weather condition or the type of auxiliary targets locations.

One alternative solution is looking for repeat patterns in the signal, assuming the peak groups are similar. Specifically, we calculate the autocorrelation and find the corresponding lag of the second largest peak in it to estimate T₁. For vehicles having more than two axles, e.g., for three-axle vehicle, the lag of the second and third largest peak in correlation plot corresponds to its two wheelbases. To estimate T₂, one can calculate the cross correlation between the two signals. Then the wheelbase and speed could be estimated using equation (1) and (2).

Another solution is to use a sliding window to search for the closest patterns among all subsequences. The signature vibration pattern of the same vehicle-passing the auxiliary targeted locations are highly repeatable. When this vibration happens, the closest distance measuring their similarity between the patterns is small. In contrast, the background noise patterns are not repeatable and thus the closest distance is high. Therefore, the proposed peak-finding algorithm can also work in this transformed closest distance space. Even if the original pattern contains multiple peaks, there is only one peak in this transformed closest distance space. The peak-finding procedure is thus more robust in this space.

Vehicle type (e.g., sedan, SUV, truck, etc.) can be directly estimated from wheelbase and number of axles.

Additional Vehicle Parameters Predicted from the Vibration Patterns.

Given the location of peaks, the signal segments containing vibration patterns can be extracted. Multiple locations over the cable can sense the same event and provide multichannel measurements. The magnitude and frequency information can be obtained by computing the power-spectrum density of the vibration pattern.

Furthermore, supervised machine learning models such as regression or classification can be trained to predict vehicle parameters. Given the ground truth label of cargo weight-in-motion and tire pressure, a model can be trained for prediction from raw waveform or power spectrum. There are at least two key aspects.

First, instead of training models individually for each label, multivariate label models should be used to consider the interaction between multiple labels, and jointly predict them (e.g., axle weight and tire pressure).

Second, the interaction also depends on the vehicle type and driving speed. They are included in the predictive model as covariates.

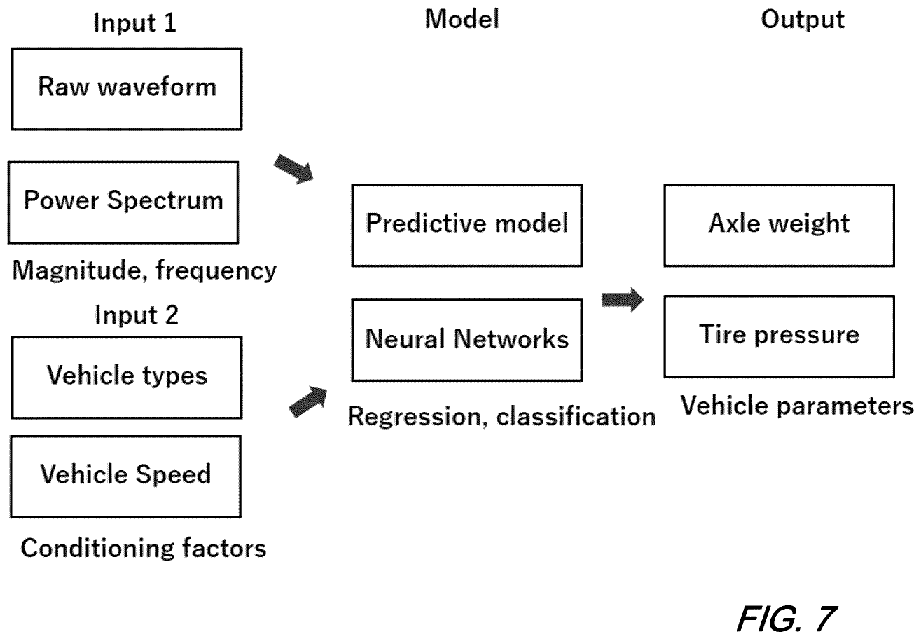

FIG. 7 is a schematic block/flow diagram showing the prediction of multi-parameter of vehicles using supervised model trained with multivariate labels according to aspects of the present disclosure and the overall scheme of the predictive model. The outputs are axle weight and tire pressures, which are jointly predicted based on two sets of inputs. The first set of input is raw waveform or power spectrum of the acoustic signals, which contains information about magnitude and frequency. The second set of input includes vehicle types and speed, which are already measured before and serve as conditioning factors.

Those skilled in the art will now appreciate our fiber sensing and machine learning based solution, for precise measurement of vehicle parameters, based on vehicle and infrastructure interaction. As noted, our sensing system includes: 1) DAS Interrogator; 2) A deployed, buried, telecommunication cable alongside a roadway; and 3) A pair of auxiliary targeted locations creating vehicle vibration (such as speed bumps, bridge decks, or sonic nap alert pattern (SNAP).

Our software includes algorithms for data preprocessing, estimation and prediction of multiple vehicle parameters. The sensing function operates on both individual vehicles, and a collection of vehicles. Our inventive systems, methods and structures enable several smart road and smart transportation applications that enhance the safety and efficiency of highways and roadways.

TABLE 1
Classification performance (recall, accuracy)
against different baseline models.

| | | | | TRN + | | |
|---|---|---|---|---|---|---|
| | CNN + | CNN + | CNN + | WAVE- | TRN + | TRN + |
| | Waveform | PSD | MFCC | FORM | PSD | MFCC |
| Recall (%) | 0.5 | 82.86 | 92.24 | 0.5 | 74.12 | 98.49 |
| Accuracy(%) | 97.17 | 99.02 | 99.60 | 97.17 | 98.22 | 99.76 |

At this point, while we have presented this disclosure using some specific examples, those skilled in the art will recognize that our teachings are not so limited. Accordingly, this disclosure should only be limited by the scope of the claims attached hereto.

1. A method of vehicle sensing, and classification based on vehicle infrastructure interaction, the method comprising:
operating a distributed fiber optic sensing (DFOS) system having a pair of targeted sensing locations along a roadway;
determining, from DFOS data received from its operation, at least locations and number of self-repeating patterns of the DFOS data, and
determining, from the DFOS data received from its operation and associated with the locations and self-repeating patterns, information about vehicles operating on the roadway including one or more of vehicle type, tire condition, and weight-in-motion of the vehicle.

2. The method of claim 1 further comprising:
Identifying, any gaps between the locations and number of self-repeating patterns of the DFOS data.

3. The method of claim 2 further comprising:
Identifying, magnitude and frequency of an acoustic signals from the DFOS data from locations and number of self-repeating patterns of the DFOS data.

4. The method of claim 3 further comprising:
determining, instantaneous speed of the vehicle from the DFOS data from locations and number of self-repeating patterns of the DFOS data.

5. The method of claim 4 further comprising a plurality of pairs of targeted sensing locations along the roadway.

6. The method of claim 5 wherein the plurality of pairs of targeted sensing locations along the roadway are located in at least two traffic lanes of the roadway.

7. The method of claim 6 wherein the at least two traffic lanes of the roadway convey traffic in different directions.

8. The method of claim 2 further comprising determining, from the DFOS data, an estimation of the number of vehicle axles from cumulative magnitude of peaks in the DFOS data and a number of continuous increasing sections of the DFOS data.

9. The method of claim 8 further comprising applying the DFOS data to a predictive model of a trained neural network and determining an axle weight and tire pressure of a vehicle operating on the roadway.

10. The method of claim 9 wherein the DFOS data includes raw waveform data and power spectrum data and a second set of input data includes vehicle type and vehicle speed, wherein the raw waveform data and power spectrum data along with the vehicle type and vehicle speed are used as input to the predictive model.
